(19) United States
(12) Patent Application Publication
(10) Pub. No.: US 2013/0160028 A1
(43) Pub. Date: Jun. 20, 2013

(54) METHOD AND APPARATUS FOR LOW LATENCY COMMUNICATION AND SYNCHRONIZATION FOR MULTI-THREAD APPLICATIONS

(71) Applicant: John E. Black, Malvern, PA (US)

(72) Inventor: John E. Black, Malvern, PA (US)

(21) Appl. No.: 13/325,222

(22) Filed: Dec. 14, 2011

(51) Int. Cl. G06F 9/50

(52) U.S. Cl. 719/314; 719/313

(57) ABSTRACT

A computing device, a communication/synchronization path or channel apparatus and a method for parallel processing of a plurality of processors. The parallel processing computing device includes a first processor having a first central processing unit (CPU) core, at least one second processor having a second central processing unit (CPU) core, and at least one communication/synchronization (com/syn) path or channel coupled between the first CPU core and the at least one second CPU core. The communication/synchronization channel can include a request message queue configured to receive request messages from the first CPU core and to send request messages to the second CPU core, and a response message queue configured to receive response messages from the second CPU core and to send response messages to the first CPU core.

### BACKGROUND

1. Field

The instant disclosure relates generally to multiple processor or multi-core processor operation, and more particularly, to improving the efficiency of multiprocessor communication and synchronization of parallel processes.

2. Description of the Related Art

Much research has been done on using multiple processors or central processing units (CPUs) to perform computations in parallel, thus reducing the time required to complete a computational process. Such research has focused on the software level and the hardware level. At the software level, conventional communication/synchronization mechanisms used to control the parallel computations have relatively large latencies. Typically, the relatively large latencies are acceptable because the computational task is divided into relatively large pieces that can run in parallel before requiring synchronization. At the hardware level, conventional synchronization mechanisms have relatively low latencies but are focused on the synchronization of sequences of relatively few operators. Conventionally, there are relatively fine-grain multiprocessor parallelisms where multiple CPUs run almost in lock step, and there are relatively coarse multiprocessor parallelisms where each CPU may execute code for a few milliseconds before requiring synchronization with the other CPUs in the multiprocessor system.

There are many applications that could benefit from the parallel execution of sequences of a relatively large number of operators (e.g., a few hundred operators). However, conventional software synchronization mechanisms have a latency that is much too great and conventional hardware synchronization mechanisms are not equipped to handle such long sequences of operators between synchronization points.

### SUMMARY

Disclosed is a computing device, a communication/synchronization path or channel apparatus and a method for parallel processing of a plurality of processors. The parallel processing computing device includes a first processor having a first central processing unit (CPU) core, at least one second processor having a second central processing unit (CPU) core, and at least one communication/synchronization (com/syn) path or channel coupled between the first CPU core and the at least one second CPU core. The communication/synchronization channel can include a request message queue configured to receive request messages from the first CPU core and to send request messages to the second CPU core, and a response message queue configured to receive response messages from the second CPU core and to send response messages to the first CPU core.

### BRIEF DESCRIPTION OF THE DRAWINGS

FIG. 1 is a schematic view of a communication/synchronization path or channel, having a set of request and response message queues, coupled between two CPU cores, according to an embodiment;

FIG. 2 is a schematic view of a plurality of communication/synchronization paths or channels, each having a set of request and response message queues, coupled between two CPU cores, according to an embodiment;

FIG. 3 is a schematic view of a communication/synchronization path or channel coupled between each of a plurality of CPU cores, according to an embodiment;

FIG. 4 is a schematic view of a request message queue and a corresponding response message queue coupled between two CPU cores, according to an embodiment;

FIG. 5 is a schematic view of an implementation of a message queue coupled between two CPU cores, according to an embodiment;

FIG. 6 is a flow diagram of an allocation and initialization portion of a method for low latency communication and synchronization between multiple CPU cores, according to an embodiment;

FIG. 7 is a flow diagram of a message sending or writing portion of a method for low latency communication and synchronization between multiple CPU cores, according to an embodiment;

FIG. 8 is a flow diagram of a message receiving or reading portion of a method for low latency communication and synchronization between multiple CPU cores, according to an embodiment; and

FIG. 9 is a flow diagram of a deallocation and decoupling portion of a method for low latency communication and synchronization between multiple CPU cores, according to an embodiment.

### DETAILED DESCRIPTION

In the following description, like reference numerals indicate like components to enhance the understanding of the disclosed method and apparatus for providing low latency communication/synchronization between parallel processes through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

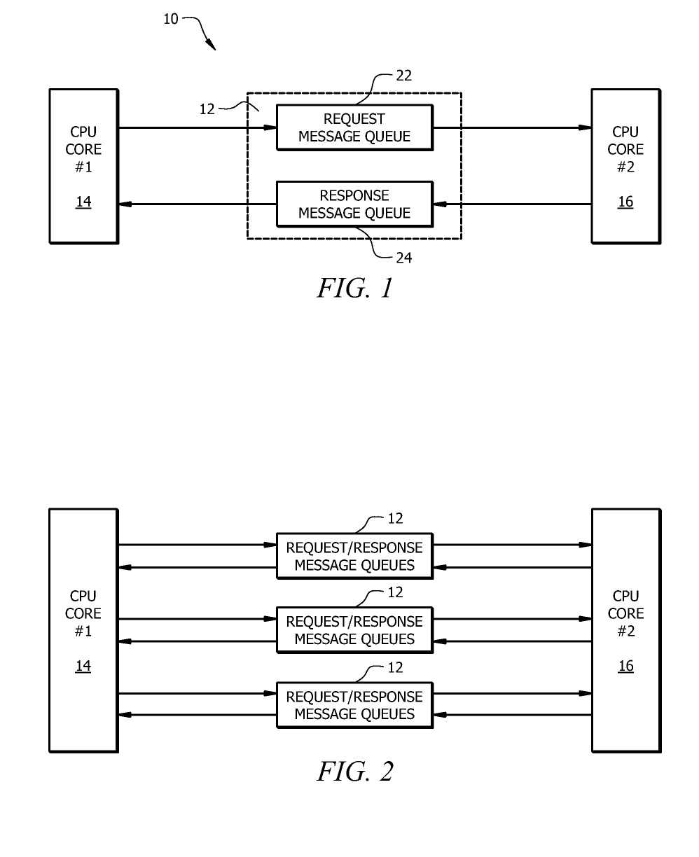

FIG. 1 is a schematic view of a computing device 10 according to an embodiment. The computing device 10 includes at least one communication/synchronization (com/syn) path or channel 12 coupled between a pair of central processing unit (CPU) cores, e.g., between a first CPU core 14 and a second CPU core 16. The com/syn channel 12 includes a set of request message and response message communications paths, i.e., a request message communications path and a corresponding response message communications path. For example, in one example implementation, each com/syn channel 12 include can include two unidirectional FIFO (first in first out) queues: a first queue 22 for sending request messages (i.e., the request message queue) and a second queue 24 for receiving responses (i.e., the response message queue). Alternatively, the com/syn channel 12 can include some kind of content addressable memory (CAM) or some other memory element for storing messages sent between the first CPU core 14 and the second CPU core 16.

Also, it should be understood that com/syn channel 12 may not include any storage components between the first CPU core 14 and the second CPU core 16. In such arrangement, a message from the first CPU core 14 is deposited directly into a register of the second CPU core 16 and no more messages are sent until the message is read by the second CPU.

The com/syn channel 12 can be used in any processor environment in which more than one CPU core exists, e.g., on a multicore processor chip or between separate processor chips. Conventionally, multiple CPU cores communicate with each other using shared data via some level of the memory heirarchy. However, access to such data is relatively slow compared to the speed of the CPU.

The com/syn channel 12 includes at least one set of request and response hardware message communications paths coupled directly between two CPU cores. In this manner, any one of the CPU cores can directly send to any other CPU core a relatively short message in just a few CPU clock cycles. Therefore, a software application can create several threads of execution to perform parallel computations and to synchronize the threads, and pass data between the threads using the relatively low latency message queues of the com/syn channel 12. In conventional arrangements, messages between multiple threads are sent through the operating system and/or shared memory of the computing device.

According to an embodiment, using the com/syn channel 12, the various parallel threads of an application can operate in any suitable manner, e.g., as a master/slave heirarchy. In this manner of operation, the master thread sends request messages via one or more request message queues to the slave threads, and receives response messages from slave threads via one or more response message queues. The slave thread receives request messages from the master thread, performs computations, and sends response messages to the master thread. Also, it should be understood that a slave thread to one master thread can also be a master of one or more other slave threads of the application. To maintain suitable operation performance, the application typically is not broken into more threads than there are CPU cores. In this manner, all of the threads of an application can be active on a different CPU core simultaneously and thus be available to process messages at the lowest possible latency.

It should be understood that the embodiment of the apparatus that sends request messages and the embodiment of the apparatus that receives response message can be identical, except for the direction of the message flow. Thus, the terms request and response can be interchanged and the CPU core that sends a request and the CPU core that receives a response also can be interchanged. If the embodiment of the apparatus used to send a request message and receive a response message is identical, except for the direction of message flow, the CPU core that sends requests and the CPU core that receives responses is established only by software convention. The actual embodiment can be symmetric.

It should be understood that, according to an embodiment, there can be more than one com/syn channel 12 coupled between any two CPU cores, e.g., between the first CPU core 14 and the second CPU core 16. For example, as shown in FIG. 2, a plurality of com/syn channels 12 are coupled between the first CPU core 14 and the second CPU core 16. As with the com/syn channel 12 in FIG. 1, each com/syn channel 12 in FIG. 2 includes a request message queue and a corresponding response message queue. For example, for hyperthreading operations, it may be advantageous to have multiple com/syn channels coupled between the two CPU cores, at least one for each hyperthreaded CPU instance. Also, it may be advantageous to use multiple com/syn channels for a variety of other reasons.

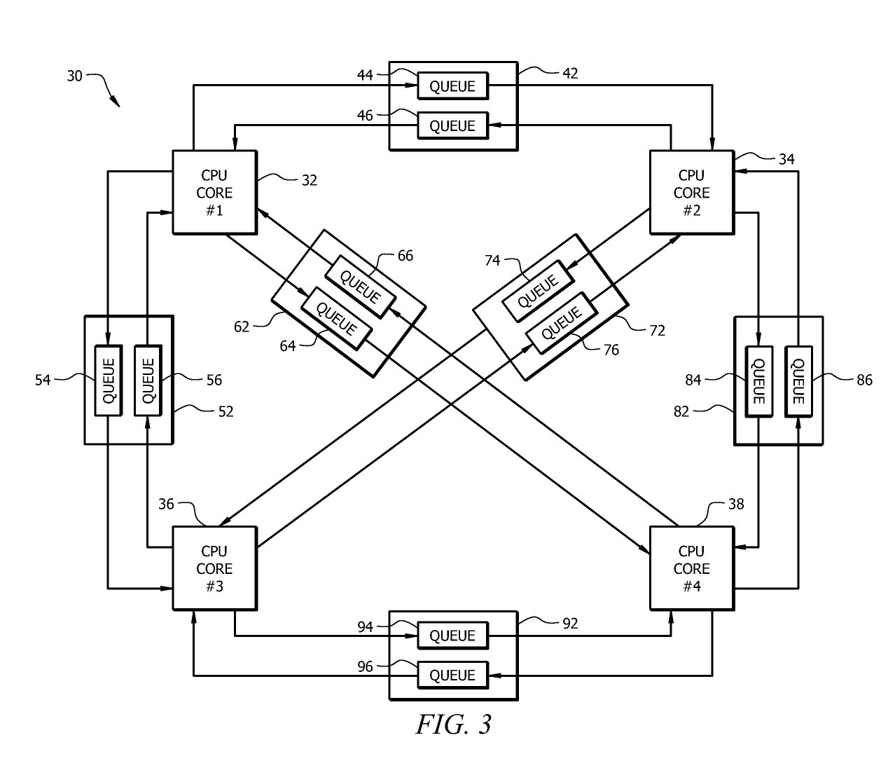

In multicore arrangements having more than two CPU cores, e.g., on the same chip, there can be at least one com/syn channel 12 coupled between each CPU core and one or more of the other CPU cores. For example, as shown in FIG. 3, a computing device 30 includes four CPU cores: a first CPU core 32, a second CPU core 34, a third CPU core 36 and a fourth CPU core 38. Also, as shown, each CPU core can include at least one com/syn channel coupled between the CPU core and every other CPU core. For example, the first CPU core 32 and the second CPU core 34 have at least one com/syn channel 42 coupled therebetween, the first CPU core 32 and the third CPU core 36 have at least one com/syn channel 52 coupled therebetween, and the first CPU core 32 and the fourth CPU core 38 have at least one com/syn channel 62 coupled therebetween. Similarly, the second CPU core 34 and the third CPU core 36 have at least one com/syn channel 72 coupled therebetween, the second CPU core 34 and the fourth CPU core 38 have at least one com/syn channel 82 coupled therebetween, and the third CPU core 36 and the fourth CPU core 38 have at least one com/syn channel 92 coupled therebetween.

As discussed hereinabove, each of the com/syn channels includes a request message communications path and a corresponding response message communications path. Thus, the com/syn channel 42 coupled between the first CPU core 32 and the second CPU core 34 can include a request message queue 44 and a corresponding response message queue 46, the com/syn channel 52 coupled between the first CPU core 32 and the third CPU core 36 can include a request message queue 54 and a corresponding response message queue 56, and the com/syn channel 62 coupled between the first CPU core 32 and the fourth CPU core 38 can include a request message queue 64 and a corresponding response message queue 66. Also, the com/syn channel 72 coupled between the second CPU core 34 and the third CPU core 36 can include a request message queue 74 and a corresponding response message queue 76, the com/syn channel 82 coupled between the second CPU core 34 and the fourth CPU core 38 can include a request message queue 84 and a corresponding response message queue 86, and the com/syn channel 92 coupled between the third CPU core 36 and the fourth CPU core 38 can include a request message queue 94 and a corresponding response message queue 96.

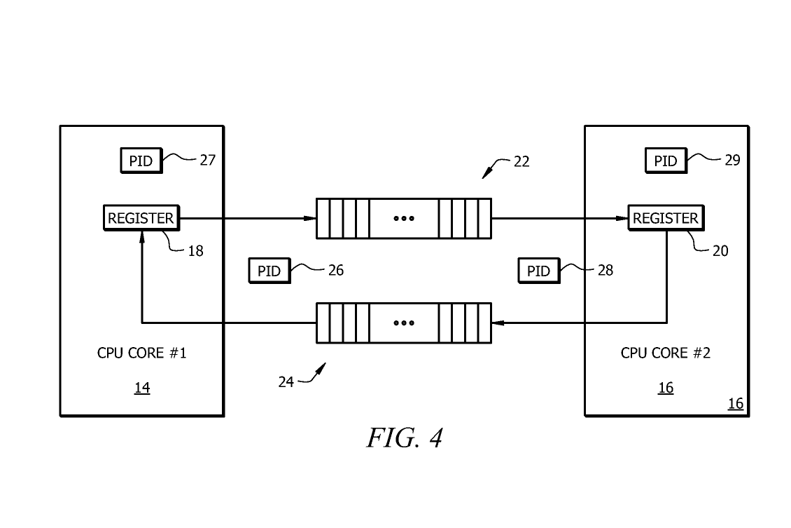

FIG. 4 is a schematic view of a request message communications path and a corresponding response message communications path coupled between two CPU cores, according to an embodiment. For example, the request message communications path can be the request message queue 22 coupled between the first CPU core 14 and the second CPU core 16, and the corresponding response message communications path can be the response message queue 24 coupled between the same two CPU cores 14, 16 (as shown in FIG. 1). As discussed hereinabove, the request message queue 22 can be a unidirectional FIFO queue, which has a first or back end that receives request messages from a register 18 in the first CPU core 14 and a second or front end from which request messages can be read, in a FIFO manner, to a register 20 in the second CPU core 16. Also, the corresponding response message queue 24 can be a unidirectional FIFO queue, which has a first or back end that receives response messages from the register 20 in the second CPU core 16 and a second or front end from which the response messages can be read, in a FIFO manner, to the register 18 in the first CPU core 14. Each of the register 18 in the first CPU core 14 and the register 20 in the second CPU core can be any suitable register, such as a general purpose register or a special purpose register or any other source of message data. In this embodiment, the request queue and response queue are shown to use the same register for sending and receiving messages. In alternative embodiments, there can be separate and/or selectable message sources and destinations for sending request messages and receiving response messages.

According to an embodiment, the use of these message communications paths allows for relatively low latency communication and synchronization between multiple CPU cores. Low latency is achieved through the use of dedicated hardware and user mode CPU instructions to insert and remove messages from these queues. By allowing user mode instructions to insert and remove messages from the queues directly, relatively high overhead kernel mode instructions are avoided and thus relatively low latency is achieved. Messages typically consist of the contents of one or more registers in the appropriate CPU core, so that the insertion of a message into a queue or the removal of a message from a queue occurs directly between the high speed CPU register and an entry in the queue. The message queue is implemented by a high speed register file and other associated hardware components. In this manner, the insertion of a message into a queue or the removal of a message from a queue typically requires just a single CPU clock cycle.

It should be understood that a message can be any suitable message that can be inserted into and removed from a queue. For example, a message can be a request code that occupies a single register in the CPU. Alternatively, a message can be a memory address from which the receiving CPU is to retrieve additional message data. Alternatively, a message can be a request code in a single register followed by one or more parameters in subsequent messages.

For security purposes, each of the back end of a message queue and the front end of a message queue can be associated with a unique process identification (PID) number or a thread identification (TID) number. This PID or TID number must be favorably compared to a PID or TID maintained by the operating system (OS) and entered into a register within the CPU core for proper delivery of a message to or retrieval of a message from the message queue. For example, the back end of the request message queue 22 can have a first queue PID number 26 associated therewith and the front end of the request message queue 22 can have a second queue PID number 28 associated therewith. Also, a first core PID number can be loaded into a register 27 in the first CPU core 14 by the operating system when the particular application being used by the CPU core becomes active. Similarly, a second core PID number can be loaded into a register 29 in the second CPU core 16 by the operating system when the particular application being used by the CPU core becomes active. The first queue PID 26 number must match the first core PID number 27 for the proper insertion of a message from the register 18 of the first CPU core 14 into the request message queue 22. Also, the second queue PID number 28 must match the second core PID number 29 for the proper removal or retrieval of a message from the request message queue 22 to the register 20 in the second CPU core 16. In the case where multiple applications are being multiplexed on a single CPU core, there should be multiple distinct PID numbers loaded onto the CPU core, with one distinct PID number for each application.

The response message queue 24 also uses the security mechanism discussed hereinabove to restrict insertion of a message into the first or back end of the response message queue 24 by the second CPU core 16 or removal or retrieval of a message from the second or front end of the response message queue 24 by the first CPU core 14. In this embodiment, the PID number register 26 is used to control access to the first or back end of the request message queue 22 and the second or front end of the response message queue 24. Also, the PID number register 28 is used to control access to the first or back end of the response message queue 24 and the second or front end of the request message queue 22. In other embodiments, separate PID number registers or other security mechanisms could be used to restrict application programmatic access to the com/syn channel.

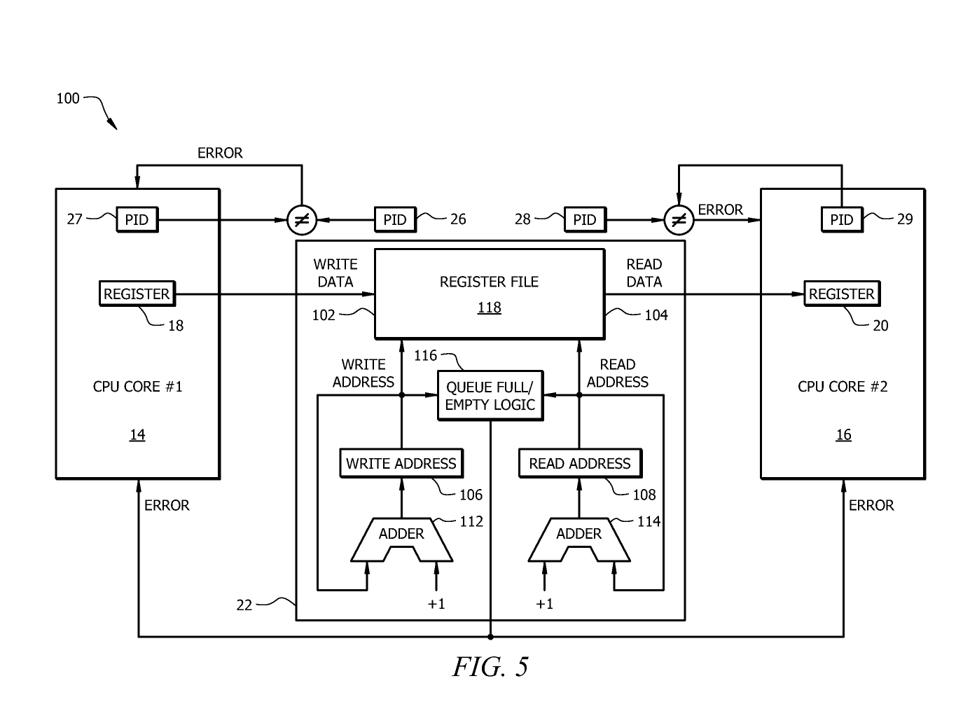

FIG. 5 is a schematic view of an implementation 100 of a message communications path coupled between two CPU cores, according to an embodiment. For example, the message communications path and its operation will be described as a request message queue, such as the request message queue 22 coupled between the first CPU core 14 and the second CPU core 16, as shown in FIG. 4. The configuration and operation of a response communications path is similar, except that the data sends and the data receives are reversed and in the opposite direction.

The request message queue 22 is a com/syn channel, e.g., implemented as a register file or other suitable memory storage element 118, coupled between a register 18 in the first CPU core 14 and a register 20 in the second CPU core 16. As discussed hereinabove, the request message queue 22 can be implemented as a FIFO queue. The register 18 in the first CPU core 14 sends data, e.g., in the form or a request message, to a back end 102 of the request message queue 22. The register 20 in the second CPU core 16 receives the data of the request message from a front end 104 of the request message queue 22. As discussed hereinabove, for a request message to be properly sent from the register 18 in the first CPU core 14 to the back end 102 of the request message queue 22, the first queue PID number 26 associated with the back end of the request message queue 22 must match the first core PID number 27 in the first CPU core 14. For a request message to be properly received from the front end 104 of the request message queue 22 by the register 20 in the second CPU core 16, the second queue PID number 28 associated with the front end 104 of the request message queue 22 must match the second core PID number 29 in the second CPU core 16.

The write address location or message slot in the request message register file 118 to which a current request message is sent is controlled or identified by a write address queue pointer register 106. Similarly, the read address location or message slot in the request message register file 118 from which a current request message is received is controlled or identified by a read address queue pointer register 108. The write address queue pointer register 106 has an adder 112 or other appropriate element coupled thereto that increments the write address location in the request message register file 118 for the next message to be sent once the current message has been sent to the current write address location in the request message register file 118. The read address queue pointer register 108 also has an adder 114 or other appropriate element coupled thereto that increments the read address location in the request message register file 118 from which the next message is to be received once the current message has been received from the current read address location in the request message register file 118. The write address queue pointer register 106 and the read address queue pointer register 108 are maintained in and updated by the appropriate hardware implementation.

Appropriate checks for queue full status and queue empty status are performed by appropriate hardware, e.g., by register full/empty logic 116 coupled to both the write address queue pointer register 106 and the read address queue pointer register 108. The register full/empty logic 116 also is coupled to the first CPU core 14 and the second CPU core 16 to deliver any appropriate actions to be taken when the request message register file 118 is determined to be full or empty, e.g., a wait instruction, an interrupt or an error.

Also, according to an embodiment, appropriate hardware support is provided wherever possible, e.g., for error detection and recovery, as well as for security. By performing these functions with hardware, the normal program control flow path of the application is optimized, thereby reducing overhead.

Because user mode code can access the message queues in the com/syn channels, a security mechanism is needed to prevent unauthorized access to the message queues. As discussed hereinabove, security is provided by associating each end of a queue with a specific queue PID number or TID number. However, it should be understood that other security access checks and control mechanisms can be used.

The PID number values are held in an appropriate register. The operating system (for its own internal reasons) also must maintain unique IDs for every process or thread that is active. According to an embodiment, a core PID register is added to the processor and a core PID number is loaded into the core PID register by the operating system whenever the operating system switches the process or thread that is executing on the CPU core. When a message is to be sent to or received from a com/syn channel, the hardware checks the queue and core PID numbers and the hardware allows the operation only if the PID numbers match. Access to these PID registers is restricted to kernal mode to prevent user applications from changing them. Such security implementation does not add overhead to the use of the message queues because the com/syn PID values are loaded only when the message channel is created. The CPU core PID register is changed as a standard part of the operating system process switching. Because process switching already is a relatively expensive and infrequent operation, the additional overhead of loading the CPU core PID register is negligable. Also, when a multithreaded parallel application is running, process switching should not occur often.

According to an embodiment, the use of one or more com/syn channels between two CPU cores provides for synchronization, e.g., when any one of the message queues is full or empty. If a message queue is full, there are several possible operational functions that can be performed at the message sender's end, i.e., at the CPU core attempting to write a message to the full queue. Similarly, if a message queue is empty, similar operational functions can be performed at the message receiver's end, i.e., at the CPU core attempting to read a message from an empty queue. For example, if a CPU core is attempting to write a request message to a request message queue that is full, a wait instruction code can be sent, an operating system interrupt code (call function) can be issued, a reschedule application code can be issued, or the instruction fails and a fail code is sent. By comparison, in conventional systems, synchronization is accomplished by operating system calls, e.g., to wait on events or to cause events, which require a relatively large number of instructions.

According to an embodiment, there are specified ways in which to integrate process switching and exception handling with operating system support. For example, when a message is placed in a queue and the corresponding receiving process is not currently active, an interrupt or other event can be caused by the hardware to alert the operating system of the condition. The operating system then can activate the matching process on the appropriate CPU core to begin receiving the messages. Instead of having the application itself check for errors on each queue insertion or removal, the hardware can notify the operating system via an interrupt or other event and an appropriate action can be taken. Such actions can include waiting for a short time and retrying the operation, causing an exception to be thrown, terminating the process, or some other appropriate action. By having the hardware cause traps into the operating system for error conditions, the application code is relieved of checking for errors that seldom occur, thus improving its performance.

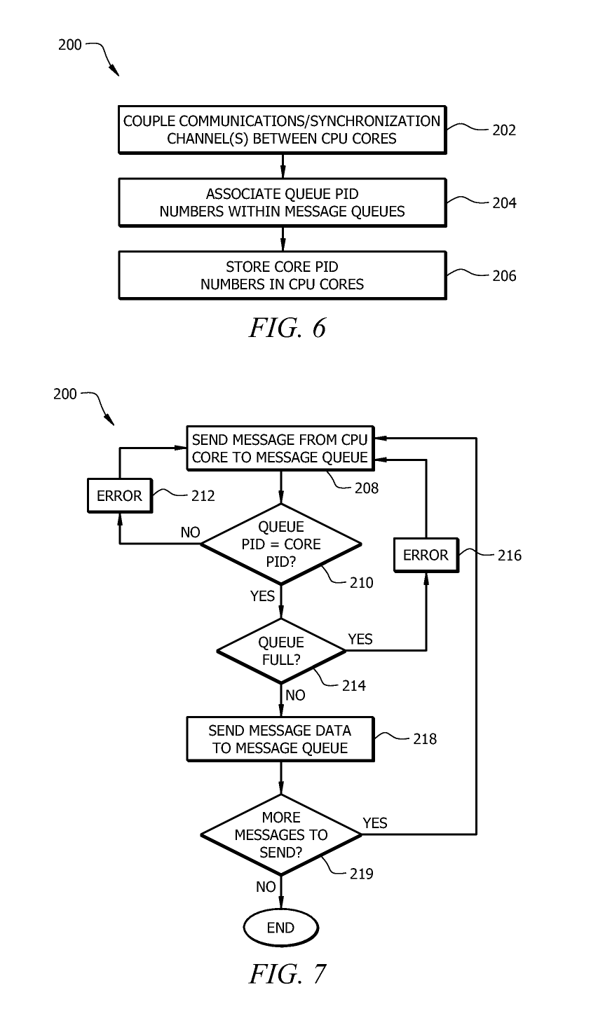

FIG. 6 is a flow diagram of an allocation and initialization portion of a method 200 for low latency communication and synchronization between multiple CPU cores, according to an embodiment. The method 200 includes a step 202 of coupling one or more communication/synchronization channels between two CPU cores. As discussed hereinabove, each communication/synchronization channel can be a FIFO message queue implemented by a high speed register file and other associated hardware components. The message queue has a back end that is coupled to a data register located within the first CPU core, and a front end that is coupled to a data register located within the second CPU core.

The method 200 also includes a step 204 of associating queue PID numbers with the message queues in each of the communication/synchronization channels. As discussed hereinabove, a first queue PID number is associated with the back end of a message queue that is part of the communication/synchronization channel, and a second queue PID number is associated with the front end of the same message queue.

The method 200 also includes a step 206 of storing or loading core PID numbers in the first and second CPU cores. For example, the operating system loads a first core PID number into a register in the first CPU core when the particular application being used by the CPU core becomes active. The first core PID number should match the queue PID number associated with the back end of the message queue, which is coupled to the first CPU core. The operating system also loads a second core PID number into a register in the second CPU core when the application being used by the CPU core becomes active. The second core PID number should match the queue PID number associated with the front end of the message queue, which is coupled to the second CPU core.

The PID numbers should be set up on the queue ends before any attempt is made to use the queue. Typically, the particular application being used requests that the PID numbers be set up on the queue. The CPU PID number is loaded with the application PID number before the communications link is set up. If the queue is not currently assigned, the PID numbers on both ends are set to an invalid PID value (e.g., zero, as zero typically is never used as a PID number) so that no process can insert or remove messages from the queue. Also, there typically is a mechanism for the operating system to clear the queue, e.g., in case some prior usage left data in the queue. Typically, the queue is cleared by resetting the read and write queue pointer registers to the same location, which typically indicates an empty queue.

FIG. 7 is a flow diagram of a message sending or writing portion of the method 200 for low latency communication and synchronization between multiple CPU cores, according to an embodiment. The message sending portion of the method 200 includes a step 208 of sending a message from the CPU core to the message queue. For example, the step 208 involves sending a request message from the first CPU core to the back end of a request message queue or a response message from the second CPU core to the back end of a response message queue. As discussed hereinabove, the contents of the request message can be a request code, a memory address or reference, a request code followed by one or more parameters, or some other type of message. For response messages, the contents also can be some type of computational result.

The message sending portion of the method 200 also includes a step 210 of determining whether the application currently executing on the CPU core has the necessary security access rights to send a request or response message to the back end of the message queue coupled to the CPU core. For example, the queue PID number associated with the back end of the message queue can be compared to the core PID number stored in the CPU core that sent the message to the back end of the message queue. As discussed hereinabove, the queue PID number must compare favorably to the core PID number for the proper insertion of the message from the CPU core into the back end of the message queue. If the queue PID number does not compare favorably to the core PID number (N), the message sending portion of the method 200 proceeds to an error step 212 in which an appropriate error indication is generated and sent to the appropriate CPU core. If the queue PID number compares favorably to the core PID (Y), the message sending portion of the method 200 proceeds to a step 214 of determining whether the message queue is full.

Once a message is sent from a CPU core to the back end of the message queue coupled to the CPU core, the step 214 determines whether or not the message queue is full, i.e., whether the message queue already has stored therein as many messages as can be held in the message queue. As discussed hereinabove, the queue full/empty logic, along with the write address queue pointer and the read address queue pointer, determines whether or not the message queue is full.

If the message queue is full (Y), the message sending portion of the method 200 proceeds to an error step 216 whereby one or more appropriate error indications are generated and delivered to the appropriate CPU core, e.g., as discussed hereinabove. If the message queue is not full (N), the message sending portion of the method 200 proceeds to a step 218 of sending or writing the message data to the back end of the message queue.

Once the message data has been sent or written to the back end of the message queue, the message sending portion of the method 200 proceeds to a step 219 of determining whether or not there are more messages to be sent to the message queue. If there are more messages to be sent to the message queue (Y), the message sending portion of the method 200 returns to the step 208 of sending a message from the CPU core to the message queue. If there are no more messages to be sent to the message queue (N), the message sending portion of the method 200 proceeds to a message receiving or reading portion of the method 200, as will be discussed hereinbelow. Optionally, other computations may be performed or other messages may be sent to or received from other CPU cores between the message sending and message receiving portions of method 200.

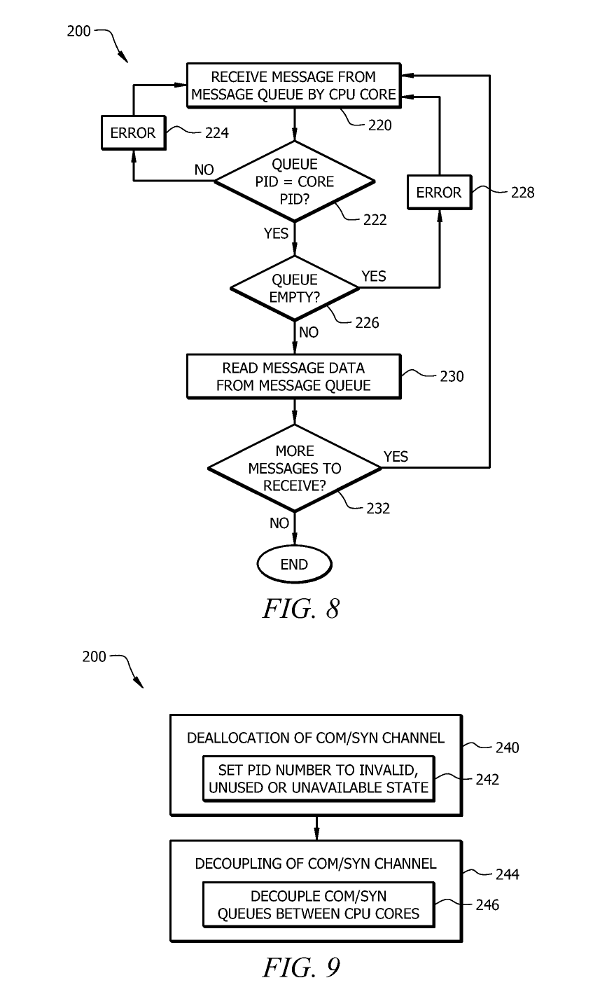

FIG. 8 is a flow diagram of a message receiving or reading portion of the method 200 for low latency communication and synchronization between multiple CPU cores, according to an embodiment. The message receiving portion of the method 200 includes a step 220 of receiving a queue message or queue message data from the message queue by the CPU core. For example, the step 220 involves receiving a request message from the front end of the request message queue by the second (slave) CPU core or receiving a response message from the front end of the response message queue by the first (master) CPU core.

The message receiving portion of the method 200 includes a step 222 of determining whether the application currently executing on the CPU core has the necessary security access rights to receive a request or response message from the front end of the message queue coupled to the CPU core. For example, the queue PID number associated with the front end of the message queue can be compared to the core PID number stored in the CPU core that is to be receiving the message from the front end of the message queue. As discussed hereinabove, the queue PID number must compare favorably to the core PID for the proper reading of the message from the front end of the message queue by the CPU core. If the queue PID number does not compare favorably to the core PID number (N), the method 200 proceeds to an error step 224 in which an appropriate error indication is generated and sent to the appropriate CPU core. If the queue PID number compares favorably to the core PID number (Y), the method 200 proceeds to a step 226 of determining whether the message queue is empty.

Once a CPU core is set to receive message data from the front end of message queue, the step 226 determines whether or not the message queue is empty, i.e., whether the message queue does not have any messages stored therein. As discussed hereinabove, the queue full/empty logic, along with the write address queue pointer and the read address queue pointer, determines whether or not the message queue is empty.

If the message queue is empty (Y), the message receiving portion of the method 200 proceeds to an error step 228 whereby one or more appropriate error indications are generated and delivered to the appropriate CPU core, e.g., as discussed hereinabove.

If the message queue is not empty (N), the message receiving portion of the method 200 proceeds to a step 230 of receiving the message data from the front end of the message queue.

Once the message data has been received from the front end of the message queue, the message receiving portion of the method 200 proceeds to a step 232 of determining whether or not there are more messages to be received from the message queue. If there are more messages to be received from the message queue (Y), the message receiving portion of the method 200 returns to the step 220 of receiving a message from the front end of the message queue. If there are no more messages to be received from the message queue (N), at some later time, the message receiving portion of the method 200 proceeds to a deallocation and decoupling portion of the method 200, as will be discussed hereinbelow. Other computations may be performed or other messages may be sent to or received from this or other CPU cores between the message receiving portions and the deallocation and decoupling portions of the method 200. Deallocation and decoupling generally will be performed near the time the application has completed and is ending.

FIG. 9 is a flow diagram of a deallocation and decoupling portion of a method 200 for low latency communication and synchronization between multiple CPU cores, according to an embodiment. The deallocation and decoupling portion of the method 200 includes a step 240 of deallocating the com/syn channel. Part of the deallocating step 240 includes a step 242 of setting the message queue and the CPU core PID numbers to an appropriate deallocation state, e.g., an invalid state, an unused state or an unavailable state.

The deallocation and decoupling portion of the method 200 also includes a step 244 of decoupling the com/syn channel. Part of the decoupling step 244 includes a step 246 of decoupling the com/syn queues between the CPU cores and removing and discarding any remaining messages from the queues.

After the completion of the decoupling step 246, the com/syn channel may be reused by the same or a different application program executing on the CPU core by beginning again from the coupling step 202 shown in FIG. 6.

In operation, multiple CPUs run relatively short sections of code (e.g., a few dozen to a few hundred operators) in parallel. Because the parallel sections of code are relatively short, a relatively fast com/syn mechanism is necessary to achieve good performance. Also, because the com/syn mechanism can make use of hardware support, parallel processing of the relatively short sections of multiple instruction/multiple data stream (MIMD) code is efficient compared to conventional software and hardware configurations.

Embodiments are not limited to just a single com/syn channel coupled between two CPU cores. As discussed hereinabove, there can be many sets of similar com/syn channels between any two endpoints. The desired com/syn channel is selected by supplying an additional parameter to the insert or remove instruction. The previously discussed PID security checking mechanism prevents different applications from interfering with each other. If each com/syn channel is used by only one application process at a time, it is unnecessary to save and restore the contents of the queues when the process executing on a core changes. A single com/syn channel can be multiplexed between multiple application processes if messages in the request or response queues are saved when the application process executing on a CPU core changes and restored when execution of the original application process resumes on that CPU core (or another CPU core).

Also, embodiments are not limited to implementations in which a com/syn channel 12 is coupled directly between two CPU cores. For example, a central routing element can be coupled between one end of a com/syn channel and a plurality of CPU cores. Alternatively, a central routing element can be coupled between a CPU core and one end of a plurality of com/syn channels that each are coupled at their other end to a corresponding plurality of CPU cores.

It should be understood that embodiments described herein can have application to any situation or processing environment in which multiple processing elements desire a low latency communication/synchronization path, such as between multiple processing elements implemented on a single field-programmable gate array (FPGA).

One or more of the CPU cores and the com/syn channels can be comprised partially or completely of any suitable structure or arrangement, e.g., one or more integrated circuits. Also, it should be understood that the computing devices shown include other components, hardware and software (not shown) that are used for the operation of other features and functions of the computing devices not specifically described herein.

The methods illustrated in FIGS. 6-9 may be implemented in one or more general, multi-purpose or single purpose processors. Such processors execute instructions, either at the assembly, compiled or machine-level, to perform that process. Those instructions can be written by one of ordinary skill in the art following the description of FIGS. 6-9 and stored or transmitted on a non-transitory computer readable medium. The instructions may also be created using source code or any other known computer-aided design tool. A non-transitory computer readable medium may be any non-transitory medium capable of carrying those instructions, and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A parallel processing computing device, comprising:
a first processor having a first central processing unit (CPU) core;
at least one second processor having a second central processing unit (CPU) core; and
at least one communication/synchronization (com/syn) channel coupled between the first CPU core and the at least one second CPU core,
wherein the at least one communication/synchronization (com/syn) channel includes
a request message communications path configured to receive request messages sent from the first CPU core and to deliver request messages to the second CPU core, and
a response message communications path configured to receive response messages sent from the second CPU core and to deliver response messages to the first CPU core.

2. The computing device as recited in claim 1, wherein at least one of the request message communications path and the response message communications path includes a message queue having associated therewith a write address queue pointer register and a read address queue pointer register, wherein the write address queue pointer register is configured to identify the position in the message queue where a current message is to be written, and wherein the read address queue pointer is configured to identify the position in the message queue where a current message is to be read from the queue.

3. The computing device as recited in claim 2, wherein the message queue has associated therewith logic to determine whether the message queue is full and to determine whether the message queue is empty.

4. The computing device as recited in claim 2, wherein the message queue has a back end and a queue process identification (PID) number associated with the back end of the message queue, and wherein the computing device further comprises logic that allows message data to be sent to the back end of the message queue only if a comparison of the queue PID associated with the back end of the message queue and a core PID stored in the CPU core coupled to the back end of the message queue determines that access to the message queue is permitted by the application currently using the CPU core.

5. The computing device as recited in claim 2, wherein the message queue has a front end and a queue process identification (PID) number associated with the front end of the message queue, and wherein the computing device further comprises logic that allows message data to be received from the front end of the message queue only if a comparison of the queue PID associated with the front end of the message queue and a core PID stored in the CPU core coupled to the front end of the message queue determines that access to the message queue is permitted by the application currently using the CPU core.

6. The computing device as recited in claim 1, wherein the first processor and the at least one second processor further comprises a plurality of processors each having a corresponding CPU core, and wherein the at least one com/syn channel further comprises at least one communication/synchronization channel coupled between each of the plurality of CPU cores of the plurality of processors.

7. The computing device as recited in claim 1, wherein at least one of the request message communications path and the response message communications path is a unidirectional first in first out (FIFO) buffer.

8. The computing device as recited in claim 1, wherein at least one of the request message communications path and the response message communications path includes a storage device for storing therein at least one message from at least one of the first CPU core and the second CPU core.

9. A communication/synchronization (com/syn) channel apparatus for parallel processing of a plurality of processors, comprising:
at least one request message communications path coupled between a CPU core of a first processor and a CPU core of a second processor,
wherein the request message communications path is configured to receive request messages from the first CPU core and to deliver request messages to the second CPU core, and
at least one response message communications path coupled between a CPU core of a first processor and a CPU core of a second processor,
wherein the response message communications path is configured to receive response messages from the second CPU core and to deliver response messages to the first CPU core.

10. The apparatus as recited in claim 9, wherein at least one of the request message communications path and the response message communications path includes a message queue having associated therewith a write address queue pointer register and a read address queue pointer register, wherein the write address queue pointer register is configured to identify the position in the queue where a current message is to be written, and wherein the read address queue pointer is configured to identify the position in the queue where a current message is to be read from the queue.

11. The apparatus as recited in claim 10, wherein the message queue has associated therewith logic to determine whether the message queue is full and to determine whether the message queue is empty.

12. The apparatus as recited in claim 10, wherein the message queue has a back end and a queue process identification (PID) number associated with the back end of the message queue, and wherein the apparatus further comprises logic that allows message data to be delivered to the back end of the message queue only if a comparison of the queue PID associated with the back end of the message queue and a core PID stored in the CPU core coupled to the back end of the message queue determines that access to the message queue is permitted by the application currently using the CPU core.

13. The apparatus as recited in claim 10, wherein the message queue has a front end and a queue process identification (PID) number associated with the front end of the queue, and wherein the apparatus further comprises logic that allows message data to be retrieved from the front end of the queue only if a comparison of the queue PID associated with the front end of the message queue and a core PID stored in the CPU core coupled to the front end of the message queue determines that access to the message queue is permitted by the application currently using the CPU core.

14. The apparatus as recited in claim 9, wherein at least one of the request message communications path and the response message communications path includes a storage device for storing therein at least one message from at least one of the first CPU core and the second CPU core.

15. A method for parallel processing of a plurality of processors, comprising:
coupling at least one communication/synchronization (com/syn) channel between a CPU core of a first processor and a CPU core of a second processor,
wherein the at least one communication/synchronization (com/syn) channel includes
a request message communications path configured to receive request messages from the first CPU core and to deliver request messages to the second CPU core, and
a response message communications path configured to receive response messages from the second CPU core and to deliver response messages to the first CPU core;
receiving by the request message communications path a request message from the first CPU core;
delivering by the request message communications path a request message to the second CPU core;
receiving by a response message queue a response message from the second CPU core; and
delivering by a response message queue a response message to the first CPU core.

16. The method as recited in claim 15, wherein at least one of the request message communications path and the response message communications path includes a message queue having associated therewith a write address queue pointer register and a read address queue pointer register, and wherein the method further comprises the write address queue pointer register identifying the position in the message queue where a current message is to be written and the read address queue pointer register identifying the position in the message queue where a current message is to be read from the queue.

17. The method as recited in claim 16, further comprising determining by logic associated with the message queue whether the message queue is full and determining whether the message queue is empty.

18. The method as recited in claim 16, wherein the message queue has a back end and a queue process identification (PID) number associated with the back end of the message queue, and wherein the method further comprises allowing message data to be delivered to the back end of the message queue only if a comparison of the queue PID associated with the back end of the message queue and a core PID stored in the CPU core coupled to the back end of the message queue determines that access to the message queue is permitted by the application currently using the CPU core.

19. The method as recited in claim 16, wherein the message queue has a front end and a queue process identification (PID) number associated with the front end of the queue, and wherein the method further comprises allowing message data to be retrieved from the front end of the message queue only if a comparison of the queue PID associated with the front end of the message queue and a core PID stored in the CPU core coupled to the front end of the message queue determines that access to the message queue is permitted by the application currently using the CPU core.
